(19) United States
(12) Patent Application Publication
(10) Pub. No.: US 2026/0037464 A1
(43) Pub. Date: Feb. 5, 2026

(54) DATA TRANSMISSION CONTROLLER AND ELECTRONIC SYSTEM

(71) Applicant: Nuvoton Technology Corporation, Hsinchu Science Park (TW)

(72) Inventor: Szu-Wei YEH, Hukou Township (TW)

(21) Appl. No.: 19/240,534

(22) Filed: Jun. 17, 2025

(30) Foreign Application Priority Data
Jul. 30, 2024 (TW) 113128257

(51) Int. Cl. G06F 13/28

(52) U.S. Cl. CPC G06F 13/28; G06F 2213/28

(57) ABSTRACT

A data transmission controller including a first master, a second master, a first slave, a second slave, a plurality of channels, a direct memory access (DMA) controller, a first command converter, and a second command converter is provided. The channels are coupled to the first or second master. The DMA controller is configured to receive a plurality of first commands, and to transmit the first commands to the channels corresponding to different data flow directions in order to transmit the first commands to the first or second master. The first and second command converters are respectively connected to the first and second slave, and are respectively connected to the second and first master through the channels. The first and second command converters are configured to convert original commands into a plurality of second commands with DMA mode.

### CROSS REFERENCE TO RELATED APPLICATIONS

This application claims priority of Taiwan Patent Application No. 113128257, filed on Jul. 30, 2024, the entirety of which is incorporated by reference herein.

### BACKGROUND OF THE INVENTION

### Field of the Invention

The present invention relates in general to a data transmission controller, and in particular it relates to a transmission controller with bridging and direct memory access (DMA) functions between subsystems in an electronic system.

### Description of the Related Art

In an electronic device (e.g., a computer) with two or more subsystems, there will be interactions where subsystems need to access each other. Since the speeds of the subsystems may differ, a bridge is required to perform asynchronous processing.

However, when one subsystem (e.g., the first subsystem) needs to access data in another subsystem (e.g., the second subsystem), the speed difference between the first and second subsystems means that the first subsystem must pass through a bridge to access the second subsystem, which results in reduced transfer performance. Therefore, to ensure optimal data transfer performance, a solution is needed to address the above issues.

### BRIEF SUMMARY OF THE INVENTION

An embodiment of the present invention provides a data transmission controller, which includes a first master, a second master, a first slave, a second slave, a plurality of channels, a Direct Memory Access (DMA) controller, a first command converter, and a second command converter. The channels are configured to be coupled to the first or second master. The DMA controller is configured to receive a plurality of first commands, and to transmit the first commands to the corresponding channels based on different data flow directions to send the first commands to the first or second master. The first and second command converters are respectively configured to connect to the first and second slaves, and are further configured to connect to the second and first master through the channels. The first and second command converters are configured to convert a plurality of original commands into a plurality of second commands in Direct Memory Access (DMA) mode.

In this embodiment, the channels are configured to receive and transmit the first commands, the second commands, and data based on different data flow directions. The channels further include a first channel, a second channel, a third channel, and a fourth channel. The first channel is configured to receive data from the first master and to transmit the data to the first master. The second channel is configured to receive data from the second master and to transmit the data to the second master. The third channel is configured for data flow from the first master to the second slave, from the first slave to the second master, or from the first master to the second master. The fourth channel is configured for data flow from the second master to the first slave, from the second slave to the first master, or from the second master to the first master.

According to some embodiments of the present disclosure, an electronic system is also provided, including a first subsystem, a second subsystem, and the data transmission controller described above. The first subsystem performs the following operations through the data transmission controller: reading data from the second subsystem or writing data to the second subsystem, reading data from the first subsystem and writing it to the second subsystem, and reading data from the first subsystem and writing it to the first subsystem. The second subsystem performs the following operations through the data transmission controller: reading data from the first subsystem or writing data to the first subsystem, reading data from the second subsystem and writing it to the first subsystem, and reading data from the second subsystem and writing it to the second subsystem.

### BRIEF DESCRIPTION OF THE DRAWINGS

The present invention can be more fully understood by reading the subsequent detailed description and examples with references made to the accompanying drawings, wherein:

FIG. 1 shows a schematic diagram of an example of an electronic system according to some embodiments;

FIG. 2 shows a schematic diagram of a data transmission controller according to some embodiments;

FIG. 3 shows a schematic diagram of a cross-subsystem read operation performed by the data transmission controller according to some embodiments;

FIG. 4 shows a schematic diagram of a cross-subsystem write operation performed by the data transmission controller according to some embodiments;

FIG. 5 shows a schematic diagram of a cross-subsystem operation with DMA functionality performed by the data transmission controller according to some embodiments;

FIG. 6 shows a schematic diagram of another cross-subsystem operation with DMA functionality performed by the data transmission controller according to some embodiments;

FIG. 7 shows a schematic diagram of an internal subsystem operation with DMA functionality performed by the data transmission controller according to some embodiments; and

FIG. 8 shows a schematic diagram of another internal subsystem operation with DMA functionality performed by the data transmission controller according to some embodiments.

### DETAILED DESCRIPTION OF THE INVENTION

In order to make the above and other objects, features, and advantages of the present invention more apparent and understandable, the following detailed description of preferred embodiments is provided, along with the accompanying figures, as follows.

The following summarizes several embodiments to help those skilled in the relevant technical field more easily understand the embodiments of the present invention. However, these embodiments are merely examples and are not intended to limit the embodiments of the present invention. It will be appreciated that those skilled in the relevant technical field can adjust the embodiments described below according to their needs, such as altering the processing sequence and/or including more or fewer steps than those described herein, and such adjustments do not fall outside the scope of the embodiments of the present invention.

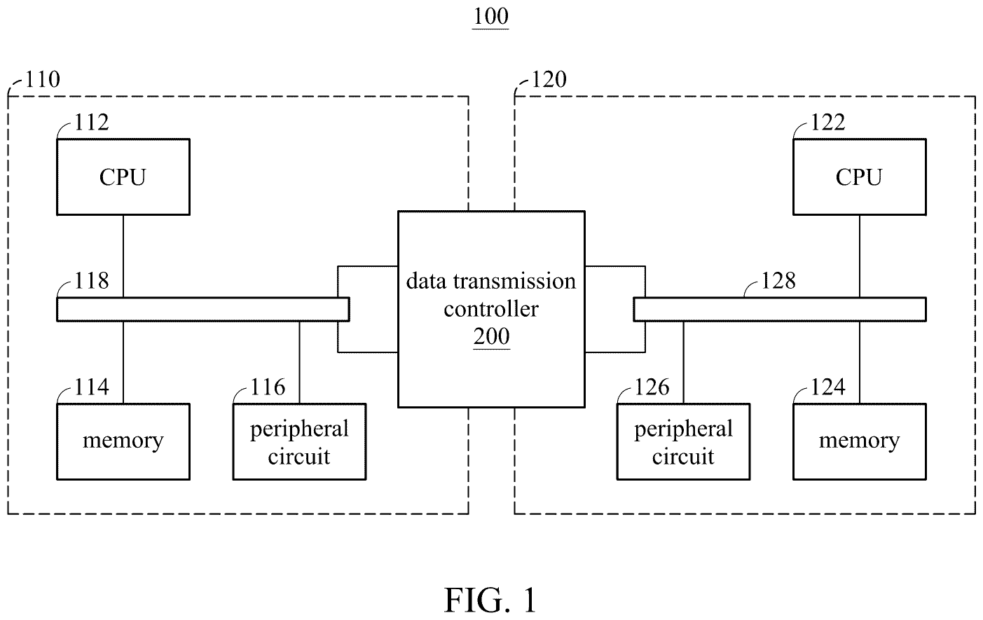

FIG. 1 is a schematic diagram of one example of an electronic system 100 according to some of the embodiments described herein. The electronic system 100 may be a system on chip (SOC) or other systems that include multiple subsystems, where the example shown in FIG. 1 is an electronic system 100 that includes two subsystems 110 and 120.

The subsystem 110 includes a central processing unit (CPU) 112, a memory 114, a peripheral circuit 116, and a bus 118. The subsystem 120 includes a CPU 122, a memory 124, a peripheral circuit 126, and a bus 128. The CPUs 112 and 122 are configured to process data and commands within subsystems 110 and 120, respectively, while memories 114 and 124 are configured to store data and commands within subsystems 110 and 120, respectively. The peripheral circuits 116 and 126 are configured to perform other operations within subsystems 110 and 120 (e.g., the respective functions of subsystems 110 and 120). As shown in FIG. 1, the CPU 112, the memory 114, and the peripheral circuit 116 are configured to be connected to the bus 118, while the CPU 122, the memory 124, and the peripheral circuit 126 are configured to be connected to bus 128. Additionally, the buses 118 and 128 are connected to a data transmission controller 200, thereby enabling data transfer across the subsystems 110 and 120 through the data transmission controller 200.

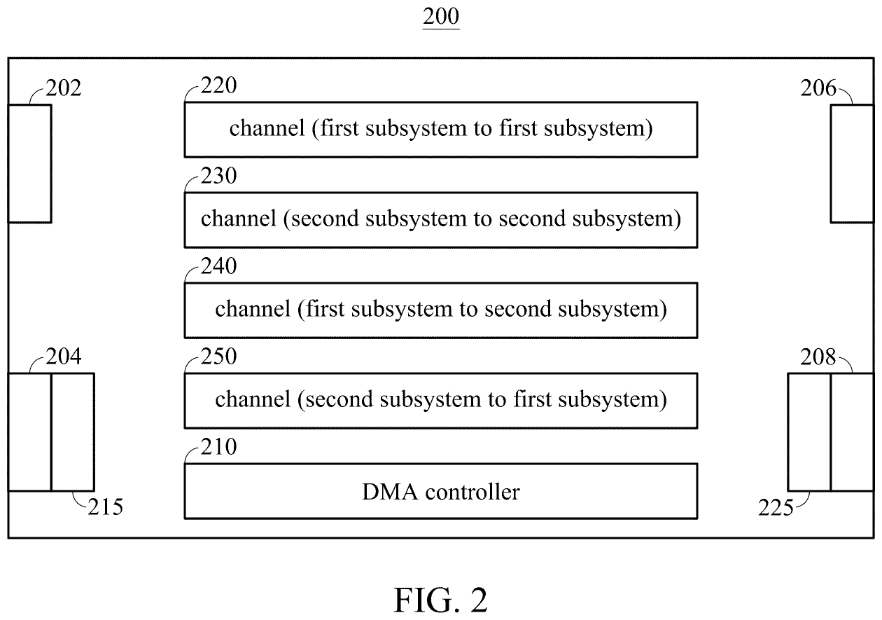

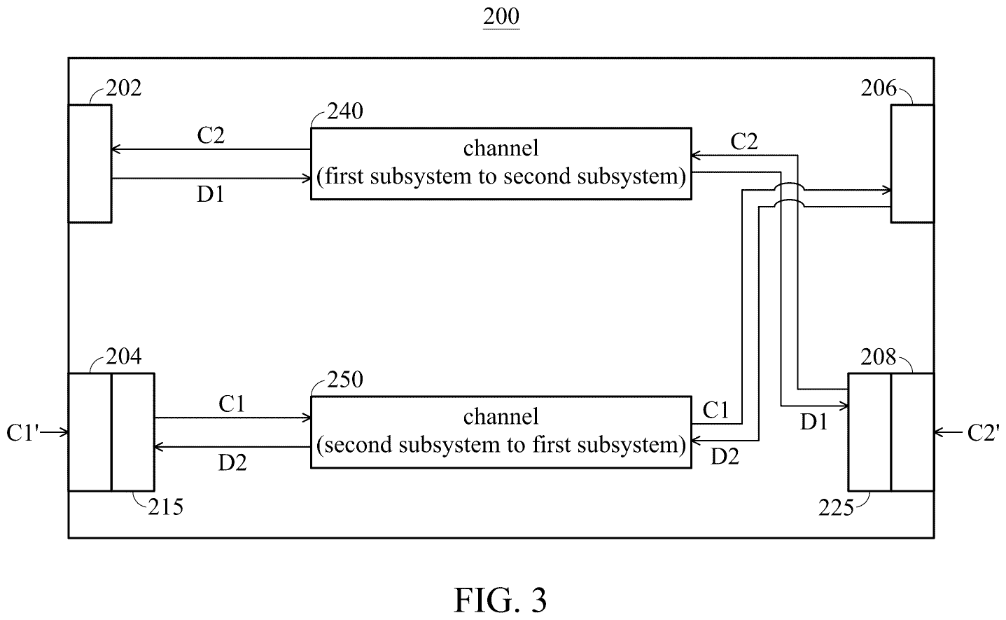

FIG. 2 is a schematic diagram of a data transmission controller 200 according to some of the embodiments described herein. The data transmission controller 200 includes a master 202 and a slave 204 connected to subsystem 110, as well as a master 206 and a slave 208 connected to subsystem 120. The data transmission controller 200 further includes a direct memory access (DMA) controller 210 and channels 220, 230, 240, and 250, where DMA controller 210 is configured to receive and execute commands and operations related to DMA functions. The channel 220 is configured for data flow to perform internal access operations for a first subsystem (e.g., internal access operations for subsystem 110), and channel 230 is configured for data flow to perform internal access operations for a second subsystem (e.g., internal access operations for subsystem 120). The channel 240 is configured for data flow from the first subsystem to the second subsystem, and channel 250 is configured for data flow from the second subsystem to the first subsystem. The operations of the masters 202 and 206, the slaves 204 and 208, the DMA controller 210, and the channels 220, 230, 240, and 250 will be explained with reference to FIGS. 3 to 8 below. Additionally, the data transmission controller 200 further includes command converters 215 and 225, which are connected to slaves 204 and 208, respectively, for converting commands from CPUs 112 and 122 on buses 118 and 128 into DMA commands.

FIG. 3 is a schematic diagram of a cross-subsystem read operation performed by the data transmission controller 200 according to some of the embodiments described herein. In one embodiment, when the CPU 112 of subsystem 110 in FIG. 1 needs to read data from the memory 124 of subsystem 120, CPU 112 sends an original command C1′ (e.g., a read operation command) through bus 114 to the slave 204 of the data transmission controller 200. The original command C1′ is then converted into a command C1 (e.g., a DMA-mode command C1) that is readable by the data transmission controller 200 via the command converter 215. Next, since the command C1 here represents a data read operation from subsystem 120 to subsystem 110, meaning the data flow is from subsystem 120 to subsystem 110, command C1 will be passed to channel 250, and then channel 250 will transmit command C1 to the master 206. After the master 206 receives command C1 (which indicates that a read operation is required), subsystem 120 will perform the read operation based on the content of command C1, and then transmit the read data D2 to master 206 through bus 128. Once the master 206 receives data D2, it will pass data D2 to channel 250, and channel 250 will output data D2 to subsystem 110 via command converter 215 and slave 204, thus completing the operation of subsystem 110 reading data from subsystem 120.

In one embodiment, when the CPU 122 of subsystem 120 needs to read data from the memory 114 of subsystem 110, CPU 122 sends an original command C2′ (e.g., a read operation command) through bus 124 to the slave 208 of the data transmission controller 200. The original command C2′ is then converted into a command C2 that is readable by the data transmission controller 200 via the command converter 225. Next, since the command C2 here represents a data read operation from subsystem 110 to subsystem 120, meaning the data flow is from subsystem 110 to subsystem 120, command C2 will be passed to channel 240, and then channel 240 will transmit command C2 to the master 202. After the master 202 receives command C2 (which indicates that a read operation is required), subsystem 110 will perform the read operation based on the content of command C2, and then transmit the read data D1 through bus 118 to master 202. Once the master 202 receives data D1, it will pass data D1 to channel 240, and channel 240 will output data D1 to subsystem 120 via command converter 225 and slave 208, thus completing the operation of subsystem 120 reading data from subsystem 110.

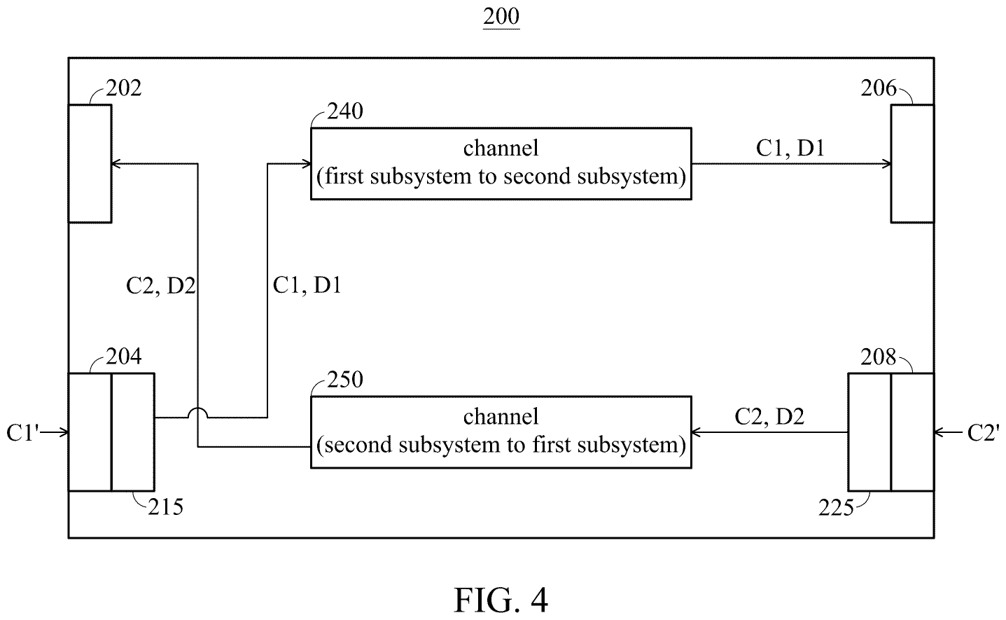

FIG. 4 is a schematic diagram of a cross-subsystem write operation performed by the data transmission controller 200 according to some of the embodiments described herein. In one embodiment, when the CPU 112 of subsystem 110 wants to write data into the memory 124 of subsystem 120, CPU 112 sends the original command C1′ (e.g., a write operation command) and data D1 through bus 118 to the slave 204. The original command C1′ is then converted into a command C1 that is readable by the data transmission controller 200 via the command converter 215. Since the operation here involves writing data from subsystem 110 to subsystem 120, meaning the data flow is from subsystem 110 to subsystem 120, the command converter 215 will pass command C1 and data D1 to channel 240. Channel 240 will then transmit command C1 and data D1 to the master 206 and output them to subsystem 120, completing the operation of writing data D1 into the memory 124 of subsystem 120.

In one embodiment, when the CPU 122 of the subsystem 120 wants to write data into the memory 114 of the subsystem 110, the CPU 122 sends the original command C2′ (e.g., a write operation command) and data D2 through the bus 128 to the slave 208. The original command C2′ is then converted into a command C2 that is readable by the data transmission controller 200 via the command converter 225. Since the operation here involves writing data from the subsystem 120 to the subsystem 110, the data flow is from subsystem 120 to subsystem 110, the command converter 225 passes the command C2 and the data D2 to the channel 250. The channel 250 then transmits the command C2 and the data D2 to the master 202 and outputs them to the subsystem 110, thereby completing the write operation of writing data D2 into the memory 114 of the subsystem 110.

It should be noted that when the command converter 215 passes the command C1 and the data D1 to the channel 240, or when the command converter 225 passes the command C2 and the data D2 to the channel 250, the data transmission controller 200 determines that the write operation has been completed. Therefore, the slave 204 and the command converter 215, or the slave 208 and the command converter 225 continue to process the subsequent (or previously interrupted) commands and data transmissions, thereby improving the performance of the data transmission controller 200. Furthermore, in the above embodiment, the commands C1 or C2 output by the command converters 215 or 225 are examples corresponding to the “second command” as disclosed herein.

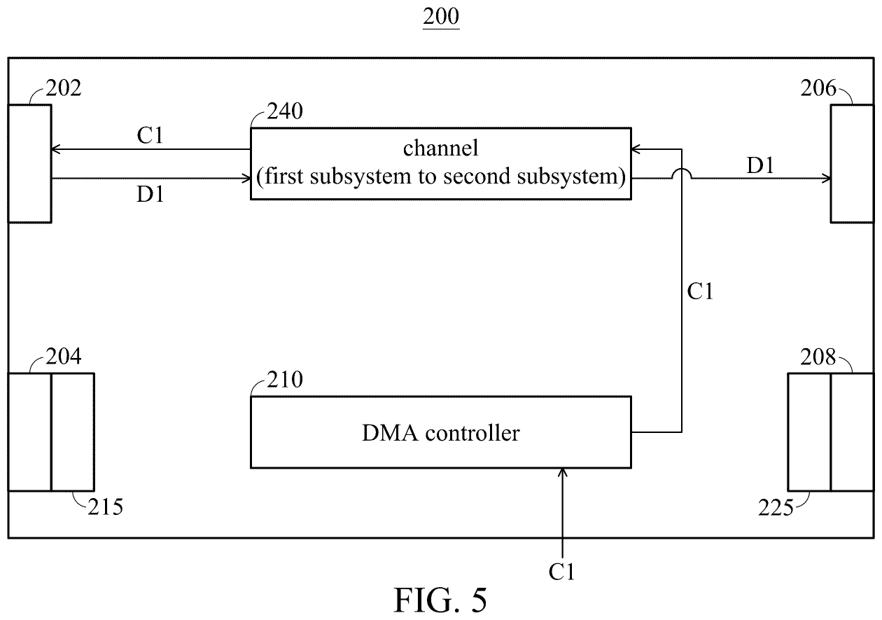

FIG. 5 is a schematic diagram of a cross-subsystem operation of the DMA function performed by the data transmission controller 200 according to some of the embodiments described herein. In one embodiment, when the CPU 112 of subsystem 110 wants to read data from memory 114 and write it to subsystem 120, the CPU 112 sends command C1 to the DMA controller 210. Since the command C1 represents reading data from subsystem 110 and then writing it to the subsystem 120, the data flow is from subsystem 110 to the subsystem 120, the command C1 is transmitted by the DMA controller 210 to the channel 240, and then data is read from subsystem 110 through channel 240 to the master 202. When the master 202 receives the read data D1, it passes the data D1 to the channel 240, which then transmits the data D1 to the master 206 and outputs it to the subsystem 120, thereby completing the operation of writing the data D1 from the subsystem 110 into the subsystem 120.

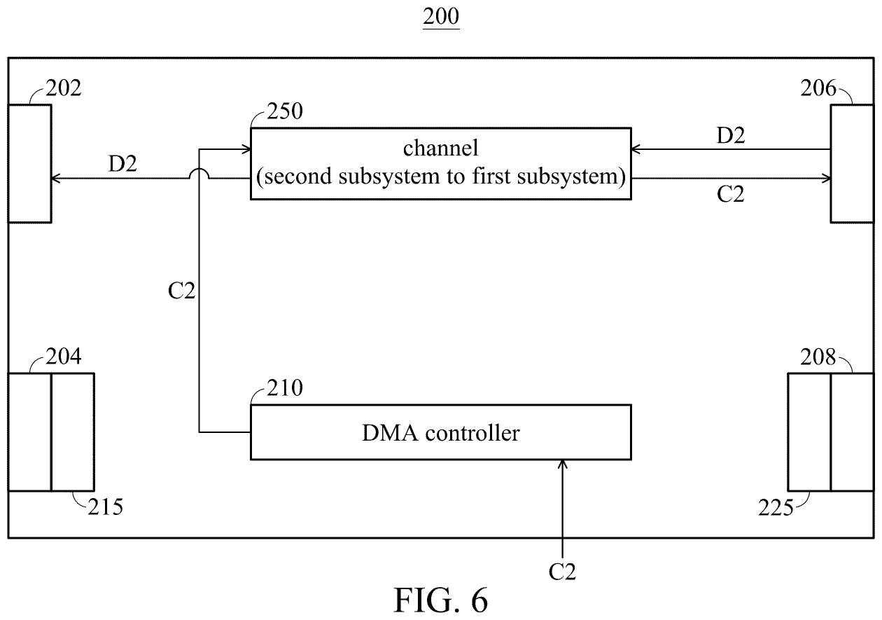

FIG. 6 is a schematic diagram of another cross-subsystem operation of the DMA function performed by the data transmission controller 200 according to some of the embodiments described herein. In one embodiment, when the CPU 122 of the subsystem 120 wants to read data from memory 124 and write it to the subsystem 110, the CPU 122 sends command C2 to the DMA controller 210. Since the command C2 represents reading data from subsystem 120 and then writing it to subsystem 110, the data flow is from subsystem 120 to subsystem 110, the command C2 is transmitted by the DMA controller 210 to channel 250, and data is then read from subsystem 120 through channel 250 to the master 206. When receiving the read data D2, the master 206 passes the data D2 to channel 250, which then transmits the data D2 to the master 202 and outputs it to subsystem 110, thereby completing the operation of writing data D2 from subsystem 120 into subsystem 110.

Similar to the cross-subsystem write operation described in FIG. 4, in the operation of reading data from the subsystem 110 and then writing it to the subsystem 120 described in FIG. 5, or in the operation of reading data from the subsystem 120 and then writing it to the subsystem 110 described in FIG. 6, when the master 202 passes data D1 to the channel 240, or when the master 206 passes the data D2 to the channel 250, the data transmission controller 200 determines that the write operation has been completed. Therefore, the master 202 or 206 can continue processing the subsequent (or previously interrupted) commands and data transmissions, thereby enhancing the performance of the data transmission controller 200. Furthermore, in the above embodiments, the commands C1 or C2 received by the DMA controller are examples corresponding to the “first command” as disclosed herein.

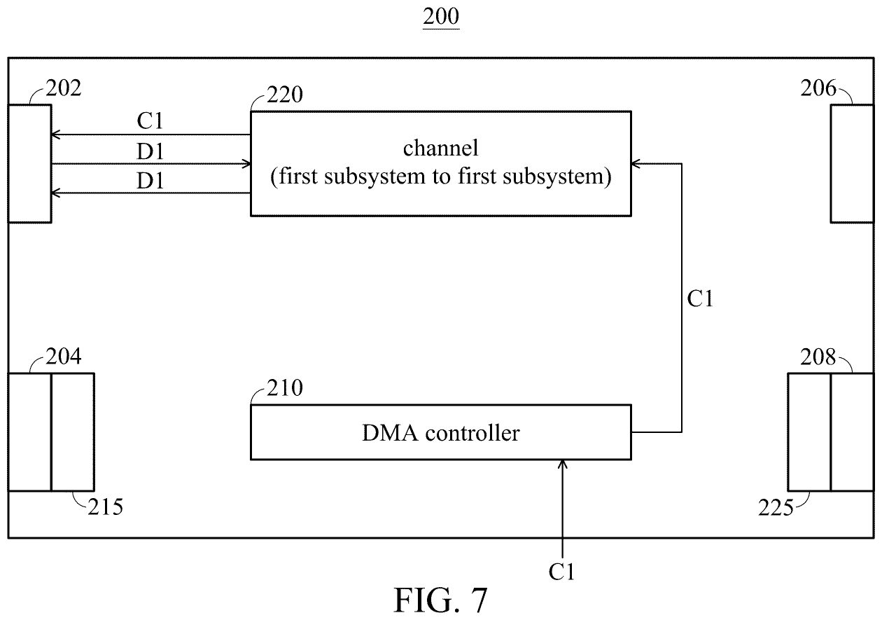

FIG. 7 is a schematic diagram of an internal subsystem operation of the DMA function performed by the data transmission controller 200 according to some of the embodiments described herein. In one embodiment, when the CPU 112 of subsystem 110 wants to read data from the subsystem 110 and write it to the subsystem 110, CPU 112 sends command C1 to the DMA controller 210. Since command C1 represents reading data from subsystem 110 and writing it to subsystem 110, meaning the data flow is from subsystem 110 to subsystem 110, command C1 is transmitted by the DMA controller 210 to the channel 220, and then through channel 220 to the master 202 to initiate the data read operation in subsystem 110. When receiving the read data D1, the master 202 passes data D1 to channel 220, which then transmits data D1 to the master 202 and outputs it to subsystem 110 to perform the write operation of data D1 into subsystem 110.

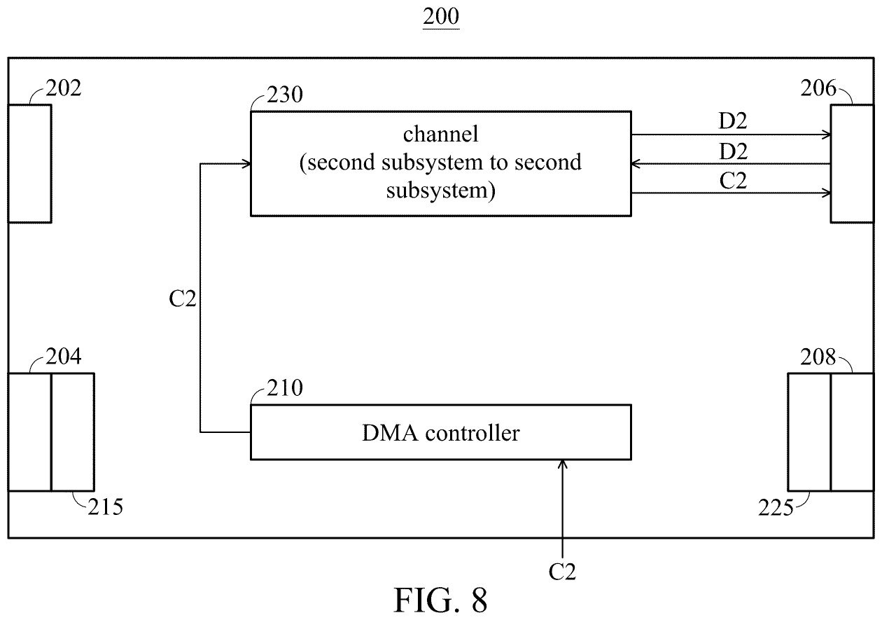

FIG. 8 is a schematic diagram of another internal subsystem operation of the DMA function performed by the data transmission controller 200 according to some of the embodiments described herein. In one embodiment, when the CPU 122 of subsystem 120 wants to read data from subsystem 120 and write it to subsystem 120, CPU 122 sends command C2 to the DMA controller 210. Since command C2 represents reading data from subsystem 120 and writing it to subsystem 120, meaning the data flow is from subsystem 120 to subsystem 120, command C2 is transmitted by the DMA controller 210 to channel 230, and then through channel 230 to the master 206 to initiate the data read operation in subsystem 120. When the master 206 receives the read data D2, it passes data D2 to channel 230, which then transmits data D2 to master 206 and outputs it to subsystem 120 to perform the write operation of data D2 into subsystem 120.

It should be noted that although the embodiments shown in FIGS. 3 to 8 are described separately in this disclosure, the aforementioned embodiments can also operate in a combined manner. Specifically, since channels 220, 230, 240, and 250 each perform data transmission for different data flows, one or more of the embodiments shown in FIGS. 3 to 8 may be performed simultaneously. For example, the operation shown in FIG. 3, where subsystem 110 reads data D2 from subsystem 120, and the internal operation of subsystem 110 shown in FIG. 7, can occur simultaneously. In this case, subsystem 110 can send the original command C1′ to slave 204 to start the read operation of data D2 from subsystem 120. At the same time, subsystem 110 can also send command C1 to master 202 to perform the read operation for data D1 in subsystem 110 and write data D1 to subsystem 110. Similarly, the operation shown in FIG. 3, where subsystem 120 reads data D1 from subsystem 110, and the internal operation of subsystem 120 shown in FIG. 8 can be performed simultaneously. The operation shown in FIG. 4, where subsystem 110 writes data D1 to subsystem 120, and the internal operation of subsystem 110 shown in FIG. 7 can also occur simultaneously. Moreover, the operation shown in FIG. 4, where subsystem 120 writes data D2 to subsystem 110, and the internal operation of subsystem 120 shown in FIG. 8 can also be performed simultaneously. However, the disclosure is not limited to these examples.

The present disclosure provides a data transmission controller that integrates the bridging function and DMA functionality, as well as an electronic system that can utilize the aforementioned data transmission controller. The electronic system includes two or more subsystems, and data transfer between subsystems can be performed through a common connection to the data transmission controller. Additionally, internal data transfer within each subsystem is also supported. When the data transmission controller performs the bridging function, it passes commands from the CPU of a subsystem to the corresponding channel based on the direction of data flow. When the required data is ready (e.g., ready for transmission), the data transmission controller transmits the data to the corresponding channel, which is then forwarded to the subsystem to complete either a read or write operation.

When the data transmission controller performs the DMA function, it receives commands from the CPU of a subsystem through the DMA controller, and then passes the commands to the corresponding channel based on the direction of data flow. The command is transmitted to the subsystem via the corresponding channel to perform data reading. The read data is returned to the channel corresponding to the data flow direction, and ultimately passed to the subsystem to complete the read and write operations.

Through the above configuration and operation, the data transmission controller provided in this disclosure can support both bridging and DMA functions. By configuring the channels according to the data flow direction, the data transmission controller provided in this disclosure can not only handle internal data transfers within each subsystem but also enable inter-system data transfers, achieving optimal performance in data access.

What is claimed is:

1. A data transmission controller, comprising:
a first master and a second master;
a first slave and a second slave;
a plurality of channels, configured to be coupled to the first master or the second master;
a direct memory access (DMA) controller, configured to receive a plurality of first commands, to transmit the plurality of first commands to the corresponding channels for different data flow directions, and to transmit the plurality of first commands to the first master or the second master through the plurality of channels;
a first command converter, configured to connect to the first slave and connect to the second master through the plurality of channels; and
a second command converter, configured to connect to the second slave and connect to the first master through the plurality of channels,
wherein the first command converter and the second command converter are configured to convert a plurality of original commands into a plurality of second commands in a direct memory access mode.

2. The data transmission controller as claimed in claim 1, wherein the channels are configured to receive and transmit the plurality of first commands, the plurality of second commands, and the plurality of data based on different data flow directions, and wherein the plurality of channels further comprise:
a first channel, configured to receive the data from the first master and transmit the data to the first master;
a second channel, configured to receive the data from the second master and transmit the data to the second master;
a third channel, configured to operate with a data flow from the first master to the second slave, from the first slave to the second master, or from the first master to the second master; and
a fourth channel, configured to operate with a data flow from the second master to the first slave, from the second slave to the first master, or from the second master to the first master.

3. The data transmission controller as claimed in claim 2, wherein when the second command is a read command from the first slave,
the first command converter converts the original command into the second command and transmits the second command to the fourth channel,
the fourth channel transmits the second command to the second master to fetch the data,
the second master transmits the received data to the fourth channel,
the fourth channel transmits the data to the first command converter, and
the first command converter transmits the data to the first slave to output the data.

4. The data transmission controller as claimed in claim 3, wherein when the second command is a read command from the second slave,
the second command converter converts the original command into the second command and transmits the second command to the third channel,
the third channel transmits the second command to the first master to fetch the data,
the first master transmits the received data to the third channel,
the third channel transmits the data to the second command converter, and
the second command converter transmits the data to the second slave to output the data.

5. The data transmission controller as claimed in claim 2, wherein
when the second command is a write command from the first slave,
the first command converter converts the original command into the second command and transmits the data and the second command to the third channel,
the third channel transmits the data and the second command to the second master to output the second command and the data; and
wherein when the second command is a write command from the second slave,
the second command converter converts the original command into the second command and transmits the data and the second command to the fourth channel, and
the fourth channel transmits the data and the second command to the first master to output the second command and the data.

6. The data transmission controller as claimed in claim 5, wherein when the direct memory access controller receives the first command, and the data flow represented by the first command is an operation from the first master to the second master,
the direct memory access controller transmits the first command to the third channel,
the third channel transmits the first command to the first master to fetch the data,
the first master transmits the received data to the third channel, and
the third channel transmits the data to the second master to output the data.

7. The data transmission controller as claimed in claim 6, wherein when the direct memory access controller receives the first command, and the data flow represented by the first command is an operation from the second master to the first master,
the direct memory access controller transmits the first command to the fourth channel,
the fourth channel transmits the first command to the second master to fetch the data,
the second master transmits the received data to the fourth channel, and
the fourth channel transmits the data to the first master to output the data.

8. The data transmission controller as claimed in claim 7, wherein when the direct memory access controller receives the first command, and the first command represents an operation of receiving the data from the first master and transmitting the data to the first master,
the direct memory access controller transmits the first command to the first channel, and the first channel then transmits the first command to the first master to fetch the data, and
the first master transmits the received data to the first channel, and the first channel then transmits the data to the first master to output the data.

9. The data transmission controller as claimed in claim 8, wherein when the direct memory access controller receives the first command, and the first command represents an operation of receiving the data from the second master and transmitting the data to the second master,
the direct memory access controller transmits the first command to the second channel, and the second channel then transmits the first command to the second master to fetch the data, and
the second master transmits the received data to the second channel, and the second channel then transmits the data to the second master to output the data.

10. An electronic system, comprising:
a first subsystem and a second subsystem; and
the data transmission controller as claimed in claim 1,
wherein the first subsystem performs the following operations via the data transmission controller:
reading data from the second subsystem or writing the read data to the second subsystem;
reading data from the first subsystem and writing the read data to the second subsystem; and
wherein the second subsystem performs the following operations via the data transmission controller:
reading data from the first subsystem or writing data to the first subsystem;
reading data from the second subsystem and writing the read data to the first subsystem; and
reading data from the second subsystem and writing the read data to the second subsystem.
